(19) United States
(12) Patent Application Publication
(10) Pub. No.: US 2008/0136780 A1
(43) Pub. Date: Jun. 12, 2008

(54) Method for generating a laser light detecting signal of an optical mouse

(76) Inventor: Yuan-Jung Chang, Hsinchuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/634,849

(22) Filed: Dec. 7, 2006

(51) Int. Cl. G06F 3/033

(52) U.S. Cl. 345/166

(57) ABSTRACT

A method for generating a laser light detecting signal for an optical mouse provides a plurality of different electrical actions of the optical mouse. The optical mouse includes at least an optical emitting unit, an optical receiving unit, a detecting unit, and a signal processing unit. The method for generating a laser light detecting signal of an optical mouse comprises the optical emitting unit generating at least one laser light. The optical receiving unit receives the laser light either directly or from the desktop. The optical receiving unit transmits a detection signal to the signal processing unit for generating a control signal. The optical mouse executes the different electrical actions by the control signal.

### BACKGROUND OF THE INVENTION

1. Field of the Invention

The present invention is related to a method for a laser light detecting signal, and more particularly, to a method for generating a laser light detecting signal of an optical mouse.

2. Description of Related Art

In general, the wireless mouse has two light emitting elements. One light emitting element uses infrared to emit light from a diode or a light bulb. Other light emitting elements use laser chips. Many methods can determine the status of a wireless mouse and whether it is being used or not. The wireless mouse generates a detection signal when the wireless mouse is moved over an operating plane. The wireless mouse performs different actions in accordance with the detection signal, wherein the different actions include disabling the wireless mouse function.

### SUMMARY OF THE INVENTION

An objective of the present invention is to provide a method for generating a laser light detecting signal for an optical mouse which controls the optical mouse electrical action.

For reaching the objective above, the present invention provides two embodiments for generating a laser light detecting signal for the optical mouse.

The first embodiment of the present invention comprises emitting a laser light generated by an optical emitting unit of the optical mouse. An optical receiving unit of the optical mouse then detects whether the laser light has been received or not. A detection unit of the optical mouse then generates a detection signal. The detection signal outputs to a signal processing unit of the optical mouse for processing the detection signal. The signal processing unit then outputs a control signal to control the electrical action of the optical mouse.

The second embodiment of the present invention comprises emitting a laser light generated by an optical emitting unit of the optical mouse on an operating plane. An optical receiving unit of the optical mouse then detects whether receives the laser light has been reflected from the operating plane or not. A detection unit of the optical mouse then generates a detection signal. The detection signal is outputted to a signal processing unit of the optical mouse for processing the detection signal. The signal processing unit then outputs a control signal to control the electrical action of the optical mouse.

Numerous additional features, benefits and details of the present invention are described in the detailed description, which follows.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic diagram of the optical mouse of the first embodiment of the present invention;

FIG. 2 is a flow chart of the optical mouse of the first embodiment of the present invention;

FIG. 3 is a schematic diagram of the optical mouse of the second embodiment of the present invention; and

FIG. 4 is a flow chart of the optical mouse of the second embodiment of the present invention.

### DETAILED DESCRIPTION OF PREFERRED EMBODIMENTS

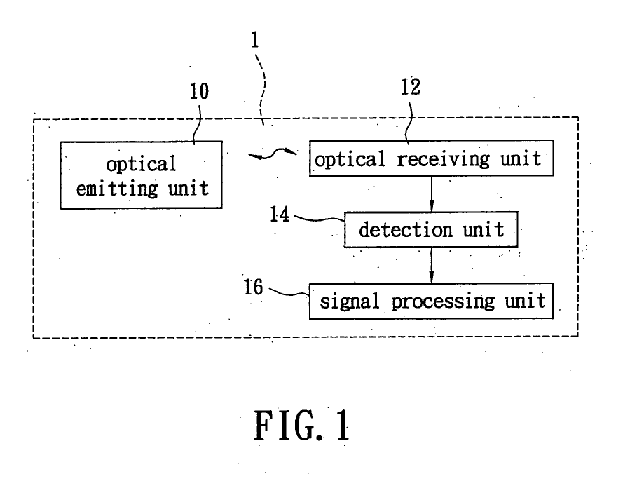

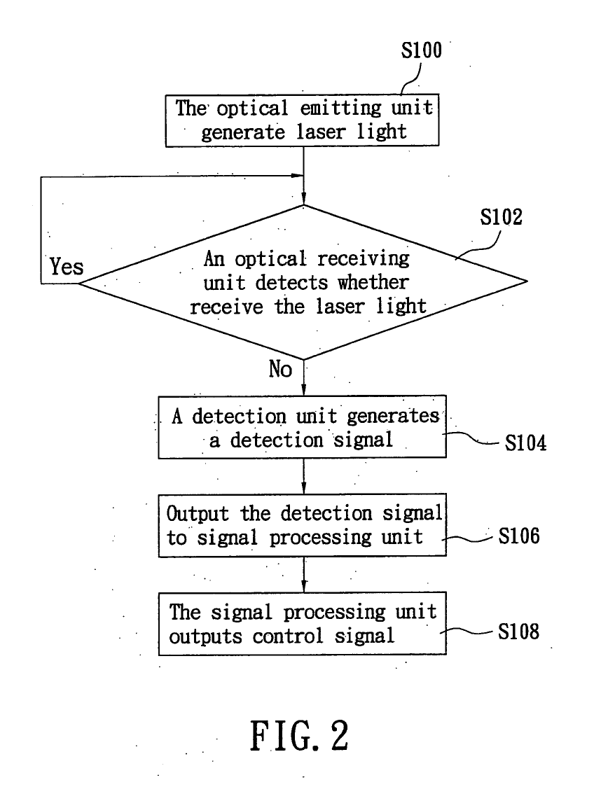

Referring to FIGS. 1 and 2, FIG. 1 shows a schematic diagram of an optical mouse of a first embodiment of the present invention. FIG. 2 shows a flow chart of the optical mouse of the first embodiment of the present invention. The optical mouse 1 of the first embodiment comprises at least an optical emitting unit 10, and an optical receiving unit 12 wirelessly connected with the optical emitting unit 10. A detection unit 14 electrically connects with the optical receiving unit 12. A signal processing unit 16 electrically connects with the detection unit 14.

The optical emitting unit 10 of the optical mouse generates a laser light (S100). The optical emitting unit 10 may be a laser chip. An optical receiving unit 12 detects whether the laser light (S102) has been received or not. The optical receiving unit 12 may be an optical sensor. In the first embodiment, the optical sensor may be an optical sensor for receiving the laser light emitting from the laser chip. If the detection result in S102 is yes, then the process returns to S102. If the detection result in S102 is no, then the detection unit 14 of the optical mouse generates a detection signal (S104).

Next, the detection signal is output to a signal processing unit 16 of the optical mouse for processing the detection signal (S106). The signal processing unit 16 may be a microprocessor. The detection signal suits signal process in accordance with the design of the signal processing unit 16. The signal processing unit 16 outputs a control signal for controlling an electrical action of the optical mouse (S108). The control signal is generated by the detection signal through the signal processing unit 16. The control signal executes electrical action in accordance with the circuit design of the optical mouse, such as close power of the optical mouse or generates a warming.

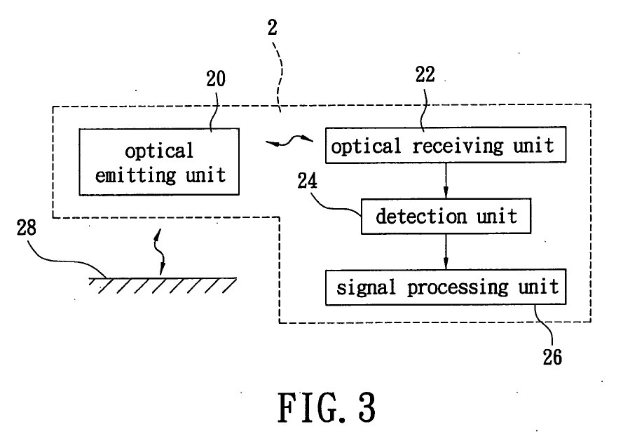

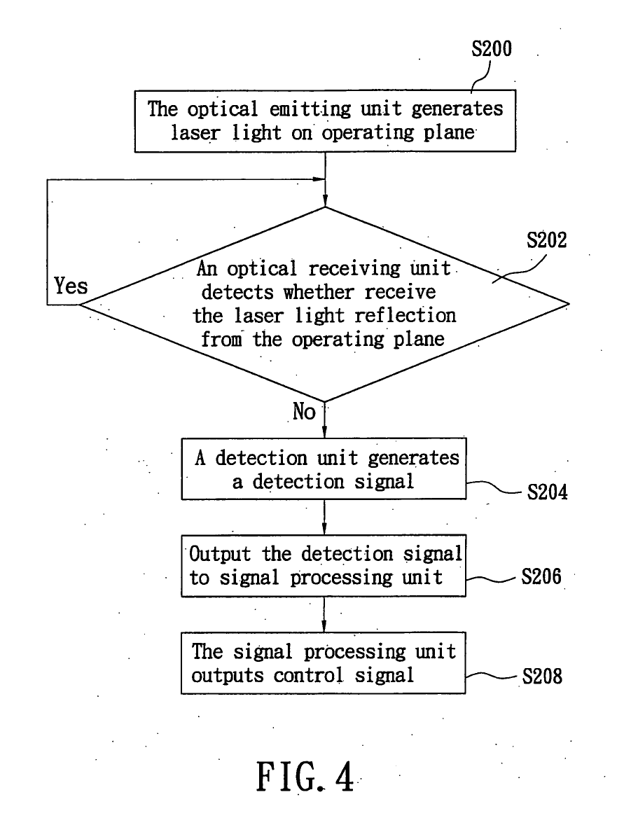

Reference to FIG. 3 and FIG. 4, FIG. 3 shows a schematic diagram of optical mouse of second embodiment of the present invention. FIG. 4 shows a flow chart of optical mouse of second embodiment of the present invention. The optical mouse of the second embodiment at least comprises an optical emitting unit 20, an optical receiving unit 22 wirelessly connects with the optical emitting unit 20. A detection unit 24 electrically connects with the optical receiving unit 22. A signal processing unit 26 electrically connects with the detection unit 24.

The optical emitting unit 20 of the optical mouse generates a laser light on an operating plane 28 (S200). The optical emitting unit 20 may be a laser chip. An optical receiving unit 22 detects whether the laser light reflection has been received from the operating plane 28 (S202). The optical receiving unit 12 may be an optical sensor. In the second embodiment, the optical sensor may be an optical sensor for receiving the laser light emitted from the laser chip. If the detection result in S202 is yes, then the process returns to S202. If the detect result in S202 is no, then the detection unit 24 of the optical mouse generates a detection signal (S204).

A detection signal is then outputted to a signal processing unit 26 of the optical mouse for processing the detection signal (S206). The signal processing unit 26 may be a microprocessor. The detection signal matches a signal process in accordance with the design of the signal processing unit 26. The signal processing unit 26 outputs a control signal for controlling an electrical action of the optical mouse (S208). The control signal is generated by the detection signal through the signal processing unit 26. The control signal executes an electrical action in accordance with the circuit design of the optical mouse, such as turning off the power of the optical mouse or generating a warming.

The laser light detecting signal is generated by one of two methods. In the first method, the optical emitting unit emits a laser light for generating a laser light detecting signal in accordance with whether or not the optical receiving unit has received the laser light. In the second method, the optical emitting unit emits a laser light on the operating plane for generating a laser light detecting signal in accordance with whether or not the optical receiving unit has received the laser light. The laser light will reach the detection unit in order to generate the detection signal. The detection signal is then transmitted to the signal processing unit. Then, the signal processing unit generates the control signal in accordance with the detection signal in order to achieve appropriate signal processing. Next, the signal processing unit controls an electrical action of the optical mouse in accordance with the circuit design of the optical mouse, such as turning off the power of the optical mouse or generating a warming.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are embraced within the scope of the invention as defined in the appended claims.

What is claimed is:

1. A method for generating a laser light detecting signal of an optical mouse, comprising:
emitting a laser light generated by an optical emitting unit of the optical mouse;
judging whether the laser light has been received from an optical receiving unit of the optical mouse;
generating a detection signal by a detection unit of the optical mouse;
processing the detection signal outputted to a signal process unit of the optical mouse; and
outputting a control signal generated by the signal process unit for controlling an electrical action of the optical.

2. The method as claimed in claim 1, wherein the optical emitting unit is a laser chip.

3. The method as claimed in claim 1, wherein the optical receive unit is an optical sensor.

4. The method as claimed in claim 1, wherein if the step of the judging result is yes, then continuing the step of judging, otherwise, if the step of the judging result is no, then generating a detection signal by a detection unit of the optical mouse.

5. The method as claimed in claim 1, wherein the signal process unit is a micro processor.

6. A method for generating a laser light detecting signal of an optical mouse, comprising:
emitting a laser light generated by an optical emitting unit of the optical mouse on an operating plane;
detecting whether the laser light received by reflecting off the operating plane by an optical receiving unit of the optical mouse;
generating a detection signal through a detection unit of the optical mouse;
outputting the detection signal to a signal processor unit of the optical mouse; and
generating a control signal outputted by the signal processor unit for controlling an electrical action of the optical mouse.

7. The method as claimed in claim 6, wherein the optical emitting unit is a laser chip.

8. The method as claimed in claim 6, wherein the optical receiving unit is an optical sensor.

9. The method as claimed in claim 6, wherein in the step of detecting the laser light, if the detecting result is yes, then returning to the step of emitting a laser light, otherwise, if the detecting result is no, then outputting the detection signal to a signal processor unit of the optical mouse.

10. The method as claimed in claim 6, wherein the signal processor unit is a micro-processor.
